(19) United States
(12) Patent Application Publication
(10) Pub. No.: US 2009/0316733 A1
(43) Pub. Date: Dec. 24, 2009

(54) OPTICAL FIBER FOR A FIBER LASER AND FIBER LASER USING THE SAME

(76) Inventors: Bing Yao, Hitachi (JP); Kazumasa Ohsono, Hitachi (JP); Akihito Hongo, Hitachi (JP); Akio Satou, Toyota (JP); Kohei Yanaka, Nishikamo (JP); Kazuya Saito, Nagoya (JP)

Correspondence Address: BRUNDIDGE & STANGER, P.C., 1700 DIAGONAL ROAD, SUITE 330, ALEXANDRIA, VA, 22314, US

(21) Appl. No.: 12/486,928

(22) Filed: Jun. 18, 2009

(30) Foreign Application Priority Data
Jun. 20, 2008 (JP) 2008-161642
Jun. 20, 2008 (JP) 2008-161643

(51) Int. Cl. H01S 3/30

(52) U.S. Cl. 372/6

(57) ABSTRACT

The present invention provides an optical fiber, for use in a fiber laser, from which a high-quality single-mode laser beam with high optical power is obtained and also provides a fiber laser that uses the optical fiber. The novel optical fiber, which includes a core to which a rare earth element is doped and a cladding formed around the core, amplifies excitation light to oscillate a laser beam. A mode filter is formed at a predetermined position in the longitudinal direction of the optical fiber.

The present application is based on Japanese Patent Application Nos. 2008-161642 and 2008-161643 filed Jun. 20, 2008, the entire contents of which are incorporated herein by reference.

### TECHNICAL FIELD

The present invention relates to an optical fiber for a fiber laser, from which a high-quality single-mode laser beam with high optical power is obtained, and to a fiber laser that uses the optical fiber.

### BACKGROUND ART

A fiber laser causes an excitation light incident into an optical fiber, for use in a fiber laser, to which an exciting material including a rare earth element is doped and then oscillates light that has been reemitted. The principle of operation will be briefly described. As shown in FIG. 7, excitation light incident into the optical fiber 101, which is an optical fiber for use in a fiber laser, excites the exciting material in the core 102, and light reemitted from the exciting material is output as a laser beam.

A conventional fiber laser 111, as shown in FIG. 8, comprises excitation optical fibers 112, used for excitation in the fiber laser, to which an exciting material is doped, mirrors 3 and 4 placed at both ends of the excitation optical fibers 112, and an excitation light incident means 5 for causing an excitation light incident into the excitation optical fibers 112.

The excitation optical fiber 112 is a step-index optical fiber, for example, in which its refraction index radially changes step by step. The optical fiber of this type in the drawing is a double-clad fiber, which has a first cladding formed around the core to which the exciting material is doped and a second cladding formed around the first cladding.

The mirrors 3 and 4 each comprise, for example, a fiber bragg grating (FBG) that selectively reflects or transmits light with a particular wavelength. The mirror at left in the drawing is the mirror 3, which is a total reflection mirror for completely reflecting light with a wavelength to be oscillated, and the mirror at right is the mirror 4, which is a partial reflection mirror for partially transmitting and partially reflecting light with a wavelength to be oscillated.

The excitation light incident means 5 comprises excitation light source and a coupler for supplying excitation light from the excitation light source to the excitation optical fibers 112. A plurality of laser diodes 7 is used as the excitation light source; excitation light from each laser diode is led to a multi-coupler 9 through light source fibers 8. The excitation light incident from the multi-coupler 9 to the excitation optical fibers 112 propagates in the excitation optical fibers 112, and is absorbed by the exciting material while being amplified, and then light is reemitted from the exciting material.

The wavelength of the excitation light is 915 or 975 nm, for example. The exciting material is ytterbium (Yb), for example. The oscillation wavelength of the laser beam is within a range from 1030 to 1100 nm, for example.

Patent Document 1: Japanese Patent Laid-open No. 2000-200931

Patent Document 2: Japanese Patent Laid-open No. 2000-349369

Patent Document 3: Japanese Patent Laid-open No. 2002-118315

Patent Document 4: Japanese Patent Application Publication No. 2007-522497

To increase fiber laser power, it suffices to increase the power of the excitation light. If the optical fiber for the fiber laser is a step-index optical fiber, however, the energy density in the optical fiber increases as the fiber laser power is increased. Accordingly, the optical fiber may be damaged or a non-linear phenomenon may occur. Another possible problem is that the optical fiber generates heat and its surroundings are thermally affected.

An effective way to solve these problems is to enlarge the mode field diameter by, for example, increasing the diameter of the optical fiber core.

If the diameter of the optical fiber core is increased, however, multi-mode laser oscillation rather than single-mode laser oscillation takes place, lowering the quality of the laser beam.

If a photonic crystal fiber (PCF) is used as the optical fiber for use in a fiber laser, the mode field diameter can be increased with the single-mode laser oscillation maintained in a wide band. However, the increase in the mode field diameter results in an increase in bending loss, making it difficult to put the PCF into practical use.

### SUMMARY OF INVENTION

The present invention provides an optical fiber for a fiber laser, from which a high-quality single-mode laser beam with high optical power is obtained and also provides a fiber laser that uses the optical fiber.

According to a first aspect of the present invention, the optical fiber for a fiber laser comprises a core doped with a rare earth element; a cladding formed around the core; and a mode filter formed at a predetermined position in a longitudinal direction of the optical fiber, the mode filter comprising a plurality of holes.

According to a second aspect of the present invention, the plurality of holes formed in the mode filter can be formed by deforming a plurality of holes formed in the cladding.

According to a third aspect of the present invention, the mode filter can be formed at each of a plurality of positions in the longitudinal direction of the optical fiber.

According to a fourth aspect of the present invention, the mode filter can be formed at a part that is linearly disposed.

According to a fifth aspect of the present invention, the mode filter can be a photonic crystal fiber disposed at the leading end of the optical fiber.

According to a sixth aspect of the present invention, the mode filter can be less than 100 mm in length.

According to a seventh aspect of the present invention, a ratio d/Λ of a diameter d of the hole to a distance Λ between the holes can be less than 0.44.

According to a eighth aspect of the present invention, a mode field diameter of the mode filter is not less than 30 μm.

The present invention can provide a fiber laser comprising: an optical fiber comprising a core doped with a rare earth element, a cladding formed around the core, and a mode filter formed at a predetermined position in a longitudinal direction of the optical fiber, the mode filter comprising a plurality of holes; and an excitation light incident means for entering excitation light into the optical fiber.

### BRIEF DESCRIPTION OF DRAWINGS

FIG. 1 shows the structure of a fiber laser in a first embodiment of the present invention.

FIG. 2 is a cross sectional view of the side of the fiber laser in the first embodiment of the present invention, indicating how light propagates in the optical fiber to explain the principle of operation of the fiber laser.

FIGS. 3A and 3B are cross sectional views of the side of a photonic crystal fiber used in the fiber laser in the first embodiment of the present invention, indicating how the photonic crystal fiber is manufactured.

FIGS. 4A and 4B partially show the structure of the fiber laser in the first embodiment of the present invention.

FIG. 5 shows the structure of a fiber laser in a second embodiment of the present invention.

FIG. 6 is a cross sectional view of the side of the fiber laser in the second embodiment of the present invention, indicating how light propagates in the optical fiber to explain the principles of operation of the fiber laser.

FIG. 7 is a perspective view of a conventional fiber laser, indicating how light propagates in the optical fiber to explain the principles of operation of the conventional fiber laser.

FIG. 8 shows the structure of the conventional fiber laser.

FIG. 9A illustrates how light propagates in a step-index optical fiber, and FIG. 9B illustrates the distribution of indexes of refraction in radial directions.

FIG. 10A illustrates a principle model of a fiber laser, FIG. 10B illustrates the relation between gain and loss in single-mode oscillation, and FIG. 10C illustrates the relation between gain and loss in multi-mode oscillation.

FIG. 11 illustrates characteristics between the bending radius and bending loss of optical fiber.

FIG. 12 is a cross sectional view of the photonic crystal fiber.

FIG. 13 illustrates characteristics of the photonic crystal fiber between the normalized wavelength and normalized frequency, with the normalized hole diameter of the photonic crystal fiber being used as a structural parameter.

FIG. 14 illustrates characteristics of the photonic crystal fiber between the hole spacing and normalized frequency and between the hole spacing and mode field diameter.

FIG. 15 illustrates characteristics of the photonic crystal fiber between the mode field diameter and bending loss.

FIG. 16 illustrates characteristics of the photonic crystal fiber between the structural parameter and normalized frequency and between the structural parameter and bending loss.

### DESCRIPTION OF EMBODIMENTS

Embodiments of the present invention will be described with reference to the attached drawings.

The present invention provides an optical fiber for a fiber laser, in which a rare earth element is doped to a core and a mode filter comprising a plurality of holes is formed at a predetermined position in a longitudinal direction of the optical fiber.

The present invention also provides an optical fiber for a fiber laser, in which a rare earth element is doped to a core and a mode filter is formed at the distal end of the optical fiber so as to suppress high-order mode oscillation.

A fiber laser having the optical fiber, for use in a fiber laser, structured as described above can obtain a laser beam with high power. The principle of operation will be considered below in detail.

Consideration needs to be given to a condition of a single-mode operation under which single-mode light propagates in the optical fiber of the fiber laser. This is because when single-mode light propagates, a high-quality laser beam is obtained. Conversely, when multi-mode light propagates, the quality of the laser beam is not high. The smaller the diameter of the cross section of the laser beam can be, the better the laser beam quality is; the quality of a laser beam in which the cross section cannot be reduced very much is not good.

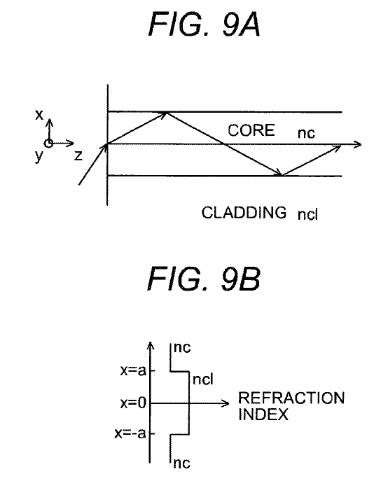

A refractive index of the core is denoted as “n_{c}”, a refractive index of the cladding is denoted as “n_{cl}”, and a radius of the core is denoted as “a”, as shown in FIGS. 9A and 9B. If equation (1) holds, then single-mode light propagates in the optical fiber.

$$\begin{matrix}[ Eq . 1 ] & \\ V ( λ ) = \frac{2 π a}{λ} \sqrt{{n}_{c}^{2} ( λ ) - {n}_{cl}^{2} ( λ )} < 2.405 & ( 1 )\end{matrix}$$

Where V(λ) is a normalized frequency. It is known that if the normalized frequency V(λ) is not more than 2.405, the optical fiber operates in the single mode. A case in which the wavelength is 1.06 μm will be considered as an example. When λ is 1.06 μm, V(λ) is 2.405, and N.A. (a value related to the enclosing of light) is 0.06 (N.A.=(n_{c}²(λ)−n_{cl}² (λ))^{1/2}), the radius of the core “a” is obtained from equation (2).

$$\begin{matrix}[ Eq . 2 ] & \\ a < \frac{λ V ( λ )}{2 π \sqrt{{n}_{c}^{2} ( λ ) - {n}_{cl}^{2} ( λ )}} < 6.6 µm & ( 2 )\end{matrix}$$

This indicates that the radius of the core “a” needed for single-mode operation is not more than 6.6 μm.

An oscillation mode in the fiber laser will be considered next.

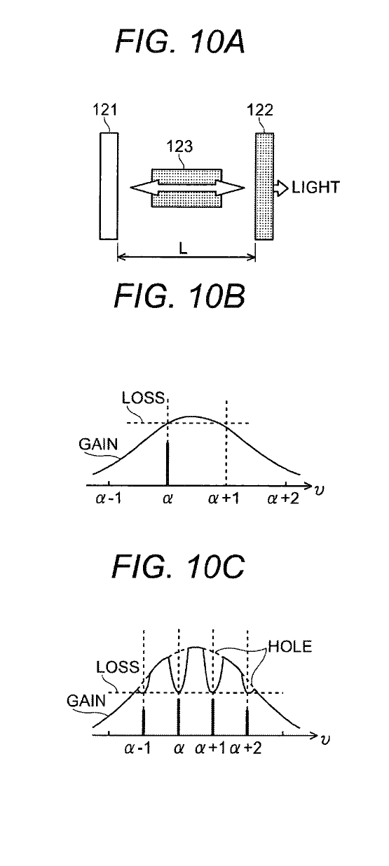

The model shown in FIG. 10A includes a total reflection mirror 121 and a partial transmission mirror 122, which are spaced by a predetermined distance L, as well as an amplifying medium 123. When excitation light (not shown) enters the amplifying medium 123, oscillation light is obtained between the total reflection mirror 121 and partial transmission mirror 122 and the oscillation light is externally emitted from the partial transmission mirror 122.

FIG. 10B illustrates the relation between gain and loss for the total reflection mirror 121 and partial transmission mirror 122. As seen from the drawing, when the gain is small as a whole, the range of frequency ν at which the gain is larger than the loss is narrow. Of the oscillation frequencies that are discretely present along the frequency axis, only oscillation frequency q is included in the range of frequency ν in which the gain is larger than the loss. Since oscillation is possible at only one frequency, the oscillation mode is the single mode.

By comparison, when the gain is large as a whole, as shown in FIG. 10C, the range of frequency ν at which the gain is larger than the loss is wide. Of the oscillation frequencies that are discretely present along the frequency axis, oscillation frequencies q−1, q, q+1, and q+2 are included in the range of frequency ν in which the gain is larger than the loss. Since oscillation is possible at a plurality of frequencies, the oscillation mode is the multi-mode.

Accordingly, to have the oscillation mode work as the single mode, the gain between the mirrors must be lowered or the loss therebetween must be raised. Then, a bending loss is generated by bending the optical fiber between the mirrors so that the oscillation mode works as the single mode.

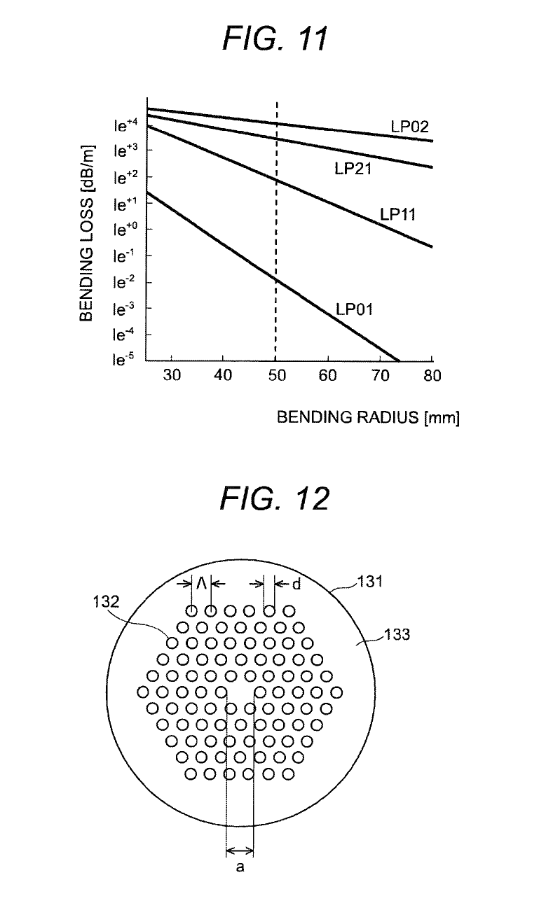

As shown in FIG. 11, when the bending radius of an optical fiber with a core diameter of 2a (=30 μm) and an NA of 0.06 is enlarged as shown on the horizontal axis, the bending loss is increased. Parameters LP02, LP21, LP11, and LP01 indicate high-order modes. When the bending radius is 50 mm, the bending loss is 50 dB/m at LP11 and 0.01 dB/m at LP01. The graph indicates that laser oscillation in each high-order mode can be efficiently removed by generating a bending loss. By comparison, in a fundamental mode (not shown), there is almost no bending loss. When the core diameter 2a exceeds 30 μm, the difference in the bending loss between the high-order modes and the fundamental mode becomes small.

Next, a case in which a photonic crystal fiber is used in the fiber laser will be considered.

As shown in FIG. 12, the photonic crystal fiber 131 is an optical fiber having holes 132. With the photonic crystal fiber 131 shown in the drawing, many holes 132 are radially formed in an optical fiber 133, which has a uniform refractive index, within a range starting from a predetermined distance from the center of the optical fiber and terminating at another predetermined distance from the center. The holes 132 are spaced at fixed intervals along three straight lines drawn on the cross section of the optical fiber at intervals of an inscribed angle of 120 degrees. The diameter of each hole 132 is denoted “d”, the distance between adjacent holes (distance between holes) is denoted Λ, the number of holes is denoted N, the refractive index of the quartz that is the material of the optical fiber 133, is denoted n, and the wavelength of light is denoted λ.

Then, the core size (radius of the core) “a” can be defined as 2Λ−d. The core is an area where light is enclosed.

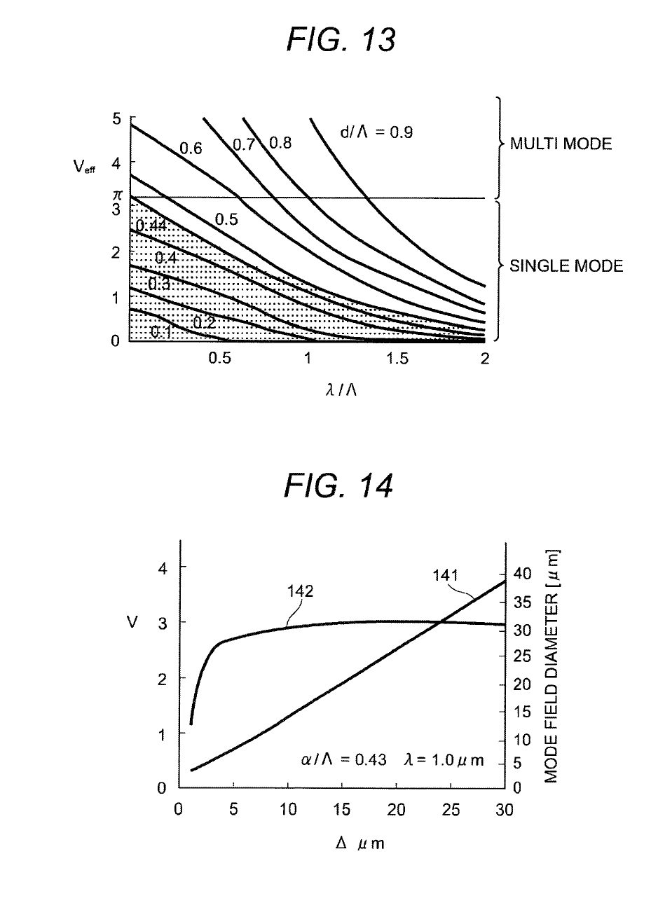

A condition under which laser oscillation is possible with the photonic crystal fiber in the single mode is obtained as described below. As shown in FIG. 13, the wavelength λ of light is divided by the distance Λ between the holes for normalization and the resulting normalized wavelength λ/Λ is taken on the horizontal axis. Normalized frequency Veff(λ) is taken on the vertical axis.

The normalized frequency Veff(λ) is represented by the following equation.

$$\begin{matrix}[ Eq . 3 ] & \\ {V}_{eff} ( λ ) = \frac{2 π a}{λ} \sqrt{{n}_{c}^{2} ( λ ) - {n}_{cl}^{2} ( λ )} & \end{matrix}$$

When the normalized frequency Veff(λ) is less than the circular constant, that is, Veff(λ)<π, laser oscillation is possible with the photonic crystal fiber in the single mode. Then, a single-mode oscillation area and a multi-mode oscillation area can be defined by using a boundary that is established when the normalized frequency Veff(λ) is π.

FIG. 13 illustrates the relation between the normalized wavelength λ/Λ and normalized frequency Veff(λ), in which the hole diameter “d” is divided by the distance Λ between holes for normalization and the resulting normalized hole diameter d/Λ is used as a parameter. As the drawing indicates, when the normalized hole diameter d/Λ is larger than a predetermined value, the normalized frequency Veff(λ) is present in both the single-mode oscillation area and multi-mode oscillation area at some values of the normalized wavelength λ/Λ; when the normalized hole diameter d/Λ is smaller than the predetermined value, the normalized frequency Veff(λ) is present only in the single-mode oscillation area, independently of the value of the normalized wavelength λ/Λ.

Specifically, when the normalized hole diameter d/Λ is less than 0.44 (within the range of the parameters in the shaded area of the graph), laser oscillation is possible with the photonic crystal fiber in the single mode.

The characteristic line 141 in FIG. 14 indicates the relation between the hole spacing Δ and mode field diameter in the photonic crystal fiber; the mode field diameter increases substantially in proportion to the increase in the hole spacing Δ. The characteristic line 142 in FIG. 14 indicates the relation between the hole spacing Δ and normalized frequency Veff(λ); even when the hole spacing A increases, the normalized frequency Veff(λ) does not exceed 3. Accordingly, in the photonic crystal fiber, the mode field diameter, which is equivalent to the radius of the core “a”, can be increased while laser oscillation is maintained in the single mode.

It can be found from the above considerations that when the photonic crystal fiber is used in the fiber laser, power can be increased by enlarging the mode field diameter while laser oscillation is maintained in the single mode.

However, the photonic crystal fiber with a large mode field diameter poses another problem in that the bending loss is increased.

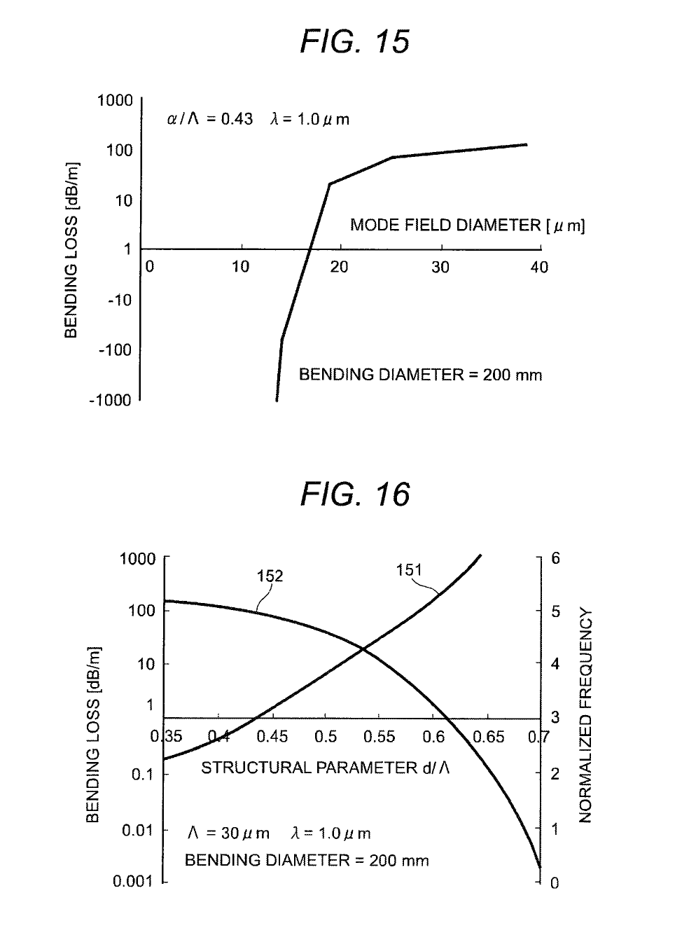

As shown in FIG. 15, when the mode field diameter of a photonic crystal fiber with its bending diameter fixed is enlarged, the bending loss is increased. In the example in the drawing, in which the bending diameter is 200 mm, the bending loss is not less than 10 dB/m when the mode field diameter is less than 20 μm, and the bending loss reaches 100 dB/m when the mode field diameter is 30 μm. Since the bending loss is large as described above, the bending diameter cannot be reduced. When the bending diameter is large, limitations are largely imposed on handling, installation, and spacing when the fiber laser is manufactured, transported, and installed.

The photonic crystal fiber has a characteristic that the bending loss is reduced as the normalized hole diameter (referred to below as the structural parameter) d/A is enlarged, as shown in FIG. 16. Specifically, when the structural parameter d/Λ is plotted on the horizontal axis and the normalized frequency Veff(Λ) is plotted on the vertical axis, the normalized frequency Veff(Λ) substantially linearly increases as the structural parameter d/Λ increases, as indicated by the characteristic line 151 in FIG. 16. When the bending loss is plotted on the vertical axis, the bending loss decreases as the structural parameter d/Λ increases, as indicated by the characteristic line 152 in FIG. 16.

That is, a photonic crystal fiber having a large structural parameter d/Λ value has a large normalized frequency and a small bending loss, and a photonic crystal fiber having a small structural parameter d/Λ value has a small normalized frequency and a large bending loss.

The embodiments of the optical fiber for a fiber laser and the fiber laser that uses the optical fiber in the present invention will be described below on the basis of the above considerations.

### Embodiment 1

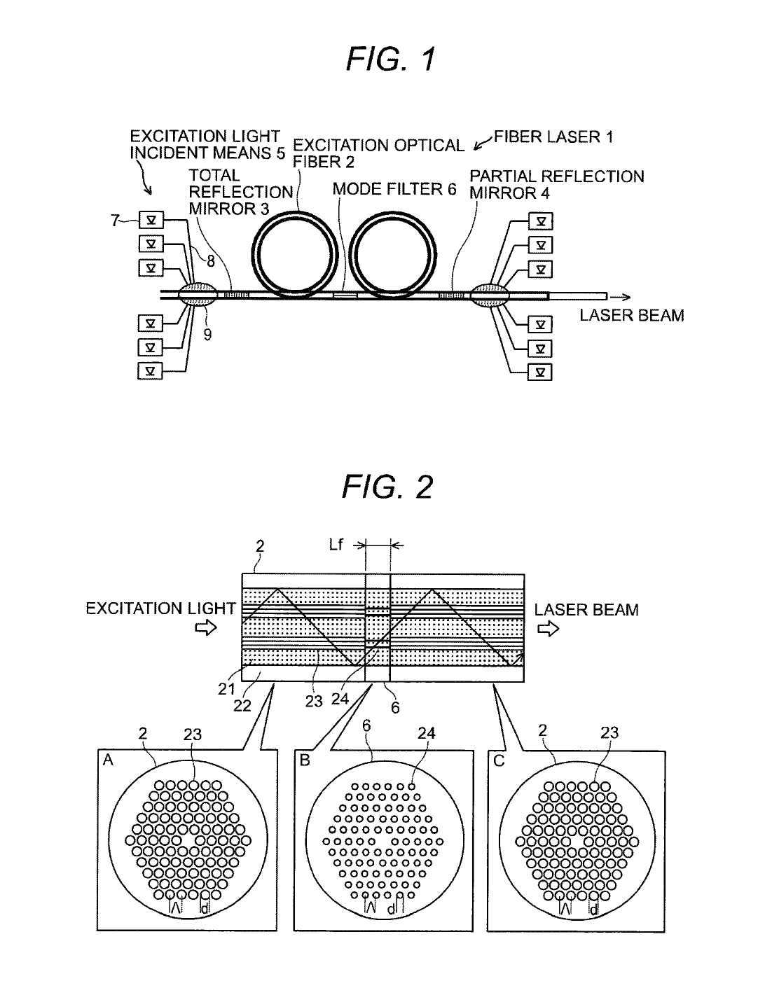

As shown in FIG. 1, in the excitation optical fiber 2, for use in a fiber laser, according to this embodiment, which has a core to which a rare earth element is doped and a cladding having a plurality of holes, the cladding being formed around the core, the excitation optical fiber 2 amplifying excitation light to oscillate a laser beam, a mode filter 6 is formed at a predetermined position in the longitudinal direction of the optical fiber.

The fiber laser 1 in this embodiment includes excitation optical fibers 2, to which an excitation material is doped, a total reflection mirror 3 disposed at an end of the excitation optical fibers 2, a partial reflection mirror 4 disposed at the other end of the excitation optical fibers 2, and an excitation light incident means 5 for entering excitation light into the excitation optical fibers 2; the excitation optical fibers 2 are photonic crystal optical fibers; a mode filter 6 is formed at a predetermined position in the longitudinal direction of the photonic crystal fibers, its d/Λ (“d” is the hole diameter, and Λ is a distance between holes) being less than 0.44.

The fiber laser 1 in this embodiment is identical to the fiber laser illustrated in FIG. 8 except that the mode filter 6 with a d/Λ (“d” is the hole diameter, and Λ is a spacing between holes) being less than 0.44 is disposed at the predetermined position in the longitudinal direction of the excitation optical fibers 2, which are photonic crystal fibers, so descriptions of the total reflection mirror 3, partial reflection mirror 4, and excitation light incident means 5 will be omitted.

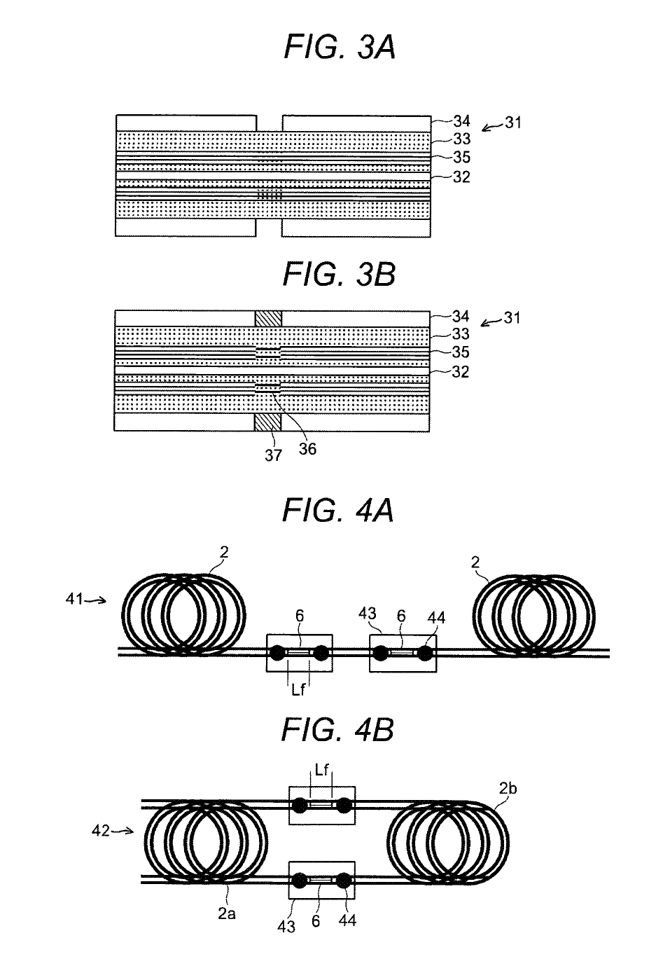

The photonic crystal fiber used as the excitation optical fiber 2 (see FIGS. 2 and 3) has a first cladding 21 to which an excitation material such as Yb is doped, a second cladding 22 formed around the first cladding 21, and a cladding layer (not shown) formed around the second cladding 22; holes 23 being formed in the first cladding 21.

The photonic crystal fiber used to form the mode filter 6 has the same number of holes 24 at the same pitch as for the holes 23, but has a structural parameter d/Λdifferent from that of the excitation optical fiber 2. In this embodiment, part of the photonic crystal fiber used as the excitation optical fiber 2 is modified in its longitudinal direction to form the mode filter 6.

FIG. 2 shows cross sections of the photonic crystal fibers at different parts. Cross-sections A and C are the cross sections of the excitation optical fibers 2, and cross section B is the cross section of the mode filter 6. The distance Λ between holes is fixed independently of the cross section. The diameter “d” of the hole 23 in cross sections A and C is larger than the diameter “d” of the hole 24 in cross section B. Specifically, the structural parameter d/Λ (normalized hole diameter) on cross sections A and C exceeds 0.44, and the structural parameter d/Λ on cross section B is less than 0.44.

The normalized hole diameter d/Λ of the photonic crystal fiber used to form the mode filter 6 is less than 0.44 (see FIG. 13), satisfying the single mode condition. That is, the mode filter 6 uses the photonic crystal fiber operating in the single mode to shut out multi-mode light (high-order mode laser beams).

The mode field diameters of the excitation optical fiber 2 and the photonic crystal fiber used to form the mode filter 6 are 30 μm, for example.

The mode filter 6 is disposed on a part that is placed by being straightened; the length Lf of the mode filter 6 is preferably less than 100 mm. If the mode filter 6 is too short, however, high-order mode laser beams transmit through the mode filter 6, so the length Lf must be larger to a certain extent.

The excitation optical fiber 2 is bent like a loop (see FIGS. 4A and 4B).

The method of manufacturing the mode filter 6 will be described below with reference to FIGS. 3A and 3B.

As shown in FIG. 3A, the photonic crystal fiber 31 has a core 32 to which an excitation material such as Yb is doped, a cladding 33 formed around the core 32, and a cladding layer 34 formed around the cladding 33; holes 35 being formed in the cladding 33. The structural parameter (normalized hole diameter) d/A of the photonic crystal fiber 31 exceeds 0.44. The cladding 34 is partially removed in the longitudinal direction of the photonic crystal fiber 31.

Then, the hole structure at the part from which the cladding 34 has been removed is modified by, for example, performing discharging carried out in ordinary fiber fusion, emitting laser beams from a laser such as a CO2 laser, or heating with a micro burner as in fiber coupler formation. Specifically, the hole diameter “d” is reduced so that the structural parameter (normalized hole diameter) d/A of the photonic crystal fiber 31 is less than 0.44.

After holes 36 have been formed from the holes 35 by reducing the hole diameter “d” of the holes 35 in this way, the cladding 34 is repaired by embedding a recoating material 37 in the part from which the cladding 34 has been partially removed. As a result, the photonic crystal fiber 31, in which the mode filter 6 is placed between the excitation optical fibers 2 and with an appropriate distance left therebetweeen, can be manufactured in the longitudinal direction of the seamless photonic crystal fiber.

The principle of operation of the optical fiber 11 in this embodiment will be briefly described next. As shown in FIG. 2, an excitation light incident on the excitation optical fiber 2 excites the exciting material in the first cladding 21 of the excitation optical fiber 2, and light reemitted from the exciting material becomes laser beams. The excitation optical fiber 2 is a photonic crystal fiber with a structural parameter (normalized hole diameter) d/Λ exceeding 0.44. Accordingly, the laser beams constitute multi-mode light. Since the laser beams pass through the mode filter 6 made of photonic crystal fiber the structural parameter d/Λ is less than 0.44, however, the laser beams become single-mode light.

The fiber laser 1 in this embodiment has an optical fiber, for use in a fiber laser, as described above; the optical fiber is formed by including excitation optical fibers 2, which have a small bending loss but operate in the multi-mode, and a mode filter 6, which has a large bending loss but can remove high-order mode light, in the longitudinal direction. The fiber laser 1 can thereby output only basic mode light. In addition, a part that must be linear is short, so the fiber laser 1 can be made compact and can be put into practical use.

The operation of the fiber laser 1 in this embodiment will be described below in detail.

As shown in FIG. 1, excitation light, having a predetermined wavelength, which is emitted from the laser diodes 7 in the excitation light incident means 5, is led through the light source fibers 8 to the multi-coupler 9. The excitation light incident from the multi-coupler 9 onto the excitation optical fibers 2 is absorbed by the exciting material while the excitation light propagates through the first claddings 21 of the excitation optical fibers 2, reemitting light from the exciting material. The total reflection mirror 3 disposed at one end of the excitation optical fibers 2 completely reflects light with a wavelength to be oscillated. The partial reflection mirror 4 disposed at the other end of the excitation optical fibers 2 partially transmits and partially reflects the light with the wavelength to be oscillated. As a result, a laser beam is output from the partial reflection mirror 4.

In this embodiment, the excitation optical fiber 2 is a photonic crystal fiber and the structural parameter d/Λ exceeds 0.44. If the mode filter 6 is not formed, when the energy of the laser beam is adequately large, the laser beams oscillated in the excitation optical fiber 2 become multi-mode laser beams.

The mode filter 6 is photonic crystal fiber, the structural parameter d/Λ of which is less than 0.44. Out of the laser beams incident from the excitation optical fiber 2 onto the mode filter 6, high-order mode laser beams do not transmit through the mode filter 6. Only the basic-mode laser beam transmits through the mode filter 6. Accordingly, the laser beam oscillated in the fiber laser 1 are single-mode laser beams, and the laser beam output from the partial reflection mirror 4 is in the single mode.

As a result, a high-quality, single-mode laser beam with high optical power is obtained.

Since, in this embodiment, a photonic crystal fiber with a small bending loss is used as the excitation optical fiber 2, a desired small bending radius or diameter can be given to the excitation optical fiber 2. By contrast, the photonic crystal fiber used to form the mode filter 6 has a large bending loss, and thereby it must be linearly used due to its large bending loss, but its length Lf is less than 100 mm, enabling the fiber laser 1 to be compact.

The structure of the photonic crystal fiber is partially modified in its longitudinal direction to change the structural parameter, so there is no connected part such as a fusion splice and thereby the connection loss can be eliminated.

The fiber laser 1 in this embodiment is not limited to a fiber laser in which only one mode filter 6 is formed as in the embodiment shown in FIG. 1. A plurality of mode filters 6 may be formed in the photonic crystal fiber used as the excitation optical fibers 2, as shown in FIGS. 4A and 4B.

In the fiber laser 41 shown in FIG. 4A, two mode filters 6 with a length (Lf) of less than 100 mm are formed between the excitation optical fibers 2. Any number of mode filters 6 greater than 2 can be formed.

In the fiber laser 42 shown in FIG. 4B, a mode filter 6 with a length (Lf) of less than 100 mm is formed between a first excitation optical fiber 2a and a second excitation optical fiber 2b, and an identical mode filter 6 is further formed on a folded segment of the second excitation optical fiber 2b. When the excitation optical fiber 2 is folded and the linear parts of a plurality of mode filters 6 are placed in parallel in this way, it is possible to prevent the entire fiber laser 42 from being elongated in one direction and thereby make the fiber laser 42 compact.

In the fiber laser 41 in FIG. 4A and fiber laser 42 in FIG. 4B, the mode filter 6 is placed on a fixing box 43 and fixed with a fixing tool 44.

### Embodiment 2

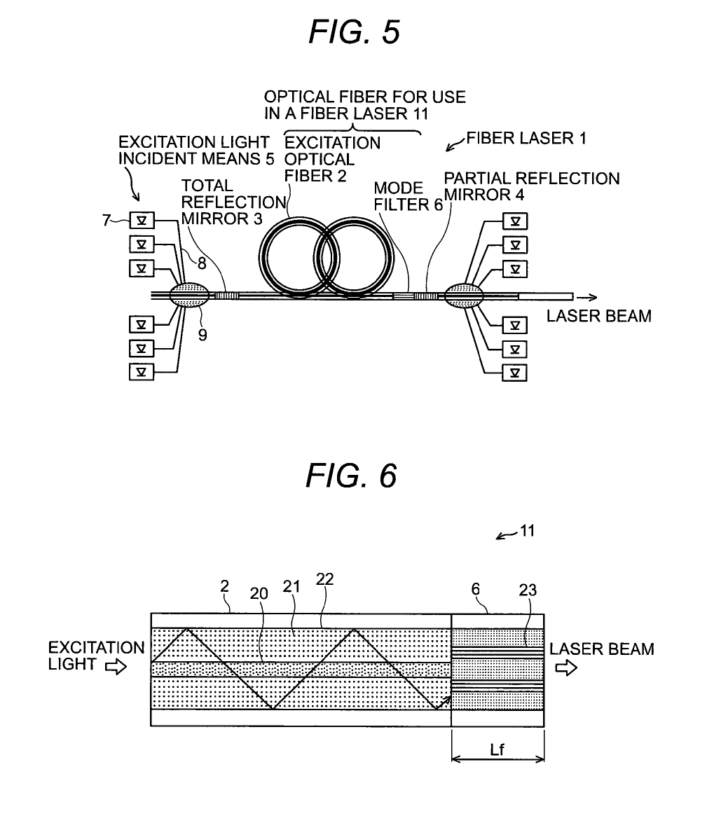

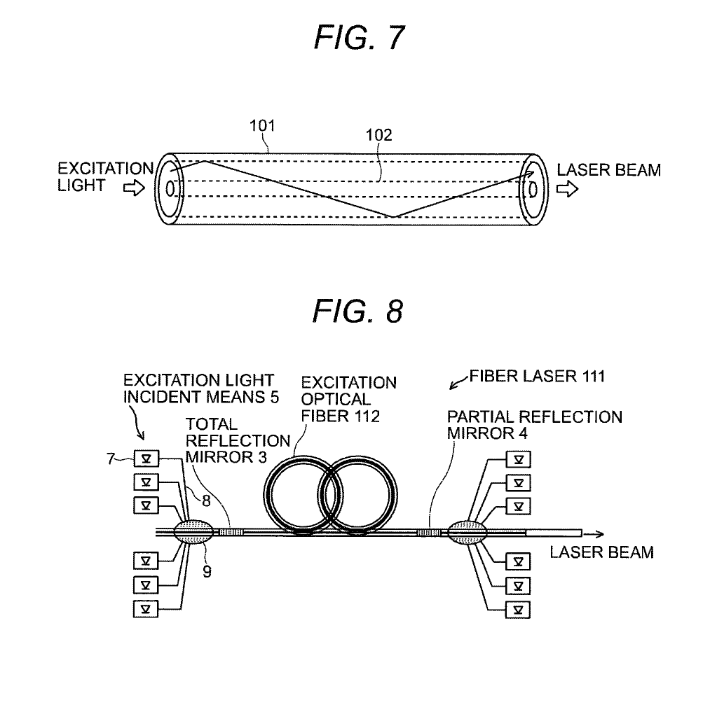

As shown in FIG. 5, the fiber laser 12 according to the present invention comprises an optical fiber 2 to which an excitation material including a rare earth element (the optical fiber comprises excitation optical fibers), a total reflection mirror 3 disposed at an end of the excitation optical fibers 2, a partial reflection mirror 4 disposed at the other end of the excitation optical fibers 2, and an excitation light incident means 5 for entering excitation light into the excitation optical fibers 2; the fiber laser 1 further comprises a mode filter 6 made of photonic crystal fiber connected to the distal end of the excitation optical fibers 2.

Thus, an optical fiber 11, for a fiber laser, in this embodiment, comprises the optical fiber (comprising excitation optical fibers) 2, in which a rare earth element is doped to the core, and the mode filter 6 connected to the leading end of the excitation optical fibers 2.

In this embodiment, the mode filter 6 is disposed between the excitation optical fibers 2 and partial reflection mirror 4.

The fiber laser 1 in this embodiment is identical to the fiber laser illustrated in FIG. 8 except that the optical fiber 11 includes the mode filter 6, which is made of photonic crystal fiber and connected to the distal end of the excitation optical fibers 2, so descriptions of the total reflection mirror 3, partial reflection mirror 4, and excitation light incident means 5 will be omitted.

The excitation optical fiber 2 (see FIG. 6) is a double-clad fiber, which has a first cladding 21 formed around the core 20 to which a rare earth element such as Yb, Er, Er/Yb, Tm, or Nd is doped and a second cladding 22 formed around the first cladding 21.

Since the mode filter 6 is connected to the leading end of the excitation optical fibers 2, the radius “a” of their core can be not less than 6.6 μm, which is the single-mode condition (see equation (2)).

Since the photonic crystal fiber used to form the mode filter 6 has holes 23, the photonic crystal fiber has almost the same structure as the photonic crystal fiber shown in FIG. 12. The outer diameter of the photonic crystal fiber used to form the mode filter 6 is the same as the outer diameter of the excitation optical fiber 2.

The normalized hole diameter d/A of the photonic crystal fiber used to form the mode filter 6 is less than 0.44 (see FIG. 13), satisfying the single-mode criterion. That is, the mode filter 6 uses photonic crystal fiber operating in the single mode to shut out multi-mode light.

The mode field diameter of the photonic crystal fiber used to form the mode filter 6 is equivalent to the core diameter of step-index optical fiber used as the excitation optical fiber 2. For example, the mode field diameter may not be less than 30 μm.

The photonic crystal fiber used to form the mode filter 6 is straightened. Its length Lf is preferably less than 100 mm. If the mode filter 6 is too short, however, high-order mode laser beams transmit through the mode filter 6, so the length Lf must be longer to a certain extent.

The photonic crystal fiber used to form the mode filter 6 and the excitation optical fiber 2 (step-index optical fiber, for example) are mutually bonded by, for example, fusion. Similarly, the FBGs used as the total reflection mirror 3 and partial reflection mirror 4 are also bonded by fusion.

The principle of operation of the optical fiber 11 in this embodiment will be briefly described next. As shown in FIG. 6, excitation light incident on the excitation optical fiber 2 excites the exciting material in the core 20 of the excitation optical fiber 2 and light reemitted from the exciting material becomes laser beams. If the core diameter of the excitation optical fiber 2 is enlarged for high power, the laser beams become multi-mode light. When the laser beam passes through the mode filter 6 made of photonic crystal fiber, however, high-order mode laser beams are suppressed and only fundamental mode laser beams can be oscillated. Accordingly, laser beams are output as single-mode light with high power.

The operation of the fiber laser 1 in this embodiment will be described below in detail.

As shown in FIG. 5, excitation light, having a predetermined wavelength, which is emitted from the laser diodes 7 in the excitation light incident means 5, is led through the light source fibers 8 to the multi-coupler 9. The excitation light incident from the multi-coupler 9 onto the excitation optical fibers 2 is absorbed by the exciting material in the core 20 while the excitation light propagates through the first claddings 21 of the excitation optical fibers 2, reemitting light from the exciting material. The total reflection mirror 3 disposed at one end of the excitation optical fibers 2 totally reflects light with a wavelength to be oscillated. The partial reflection mirror 4 disposed at the other end of the excitation optical fibers 2 partially transmits and partially reflects the light with the wavelength to be oscillated. As a result, a laser beam is output from the partial reflection mirror 4.

In this embodiment, the excitation optical fiber 2 has a core diameter (6.6 μm or more) larger than the core diameter, which is the condition for single-mode operation, enabling laser beam energy to be adequately increased. However, the laser beam oscillated in the excitation optical fiber 2 is in the multi-mode.

The optical fiber, for use in a fiber laser, to which the mode filter 6 made of photonic crystal fiber with a normalized hole diameter d/Λ less than 0.44 is formed at the leading end of the excitation optical fiber 2. Accordingly, out of the laser beams incident from the excitation optical fibers 2 onto the mode filter 6, high-order mode laser beams do not transmit through the mode filter 6. Only the fundamental mode laser beam transmits through the mode filter 6. As a result, a high-quality, single-mode laser beam with high optical power is obtained.

Since, in this embodiment, a step-index optical fiber with a small bending loss is used as the excitation optical fiber 2, a desired small bending radius or diameter can be given to the excitation optical fiber 2. By contrast, the photonic crystal fiber used to form the mode filter 6 has a large bending loss, and thereby it must be used linearly, but its length Lf is less than 100 mm, enabling the fiber laser 1 to be compact.

It will be obvious to those having skill in the art that many changes may be made in the above-described details of the preferred embodiments of the present invention. The scope of the present invention, therefore, should be determined by the following claims.

1. An optical fiber for a fiber laser comprising:
a core doped with a rare earth element;
a cladding formed around the core; and
a mode filter formed at a predetermined position in a longitudinal direction of the optical fiber, the mode filter comprising a plurality of holes.

2. The optical fiber for a fiber laser, according to claim 1, wherein the plurality of holes formed in the mode filter is formed by deforming a plurality of holes formed in the cladding.

3. The optical fiber for a fiber laser, according to claim 1, wherein the mode filter is formed at each of a plurality of positions in the longitudinal direction of the optical fiber.

4. The optical fiber for a fiber laser, according to claim 1, wherein the mode filter is formed at a part that is linearly disposed.

5. The optical fiber for a fiber laser, according to claim 1, wherein the mode filter is a photonic crystal fiber disposed at the leading end of the optical fiber.

6. The optical fiber for a fiber laser, according to claim 1, wherein the mode filter is less than 100 mm in length.

7. The optical fiber for a fiber laser, according to claim 1, wherein a ratio d/A of a diameter d of the hole to a distance Λ between the holes is less than 0.44.

8. The optical fiber for a fiber laser, according to claim 1, wherein a mode field diameter of the mode filter is not less than 30 μm.

9. A fiber laser comprising:
an optical fiber comprising a core doped with a rare earth element, a cladding formed around the core, and a mode filter formed at a predetermined position in a longitudinal direction of the optical fiber, the mode filter comprising a plurality of holes; and
an excitation light incident means for entering excitation light into the optical fiber.
